(19) United States
(12) Patent Application Publication
(10) Pub. No.: US 2004/0233301 A1
(43) Pub. Date: Nov. 25, 2004

(54) Digital camera

(75) Inventors: Shin Nakata, Kanagawa (JP); Yuanzhong Li, Kanagawa (JP); Takayuki Iida, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/850,378

(22) Filed: May 21, 2004

(30) Foreign Application Priority Data
May 23, 2003 (JP) 2003-146399

(51) Int. Cl. H04N 5/262

(52) U.S. Cl. 348/239; 348/222.1

(57) ABSTRACT

The digital camera includes a photographing unit for photoelectrically photographing an image, a display for displaying a photographed image, a red-eye processing unit for detecting red-eye from the photographed image to generate red-eye position information and a red-eye control unit for displaying on the display an enlarged image obtained by enlarging a red-eye region including the detected red-eye in accordance with the red-eye position information. Further, the red-eye processing unit executes red-eye correction to correct the detected red-eye.

### BACKGROUND OF THE INVENTION

The present invention relates to the technical field of a digital camera, and more particularly to a digital camera capable of detecting red-eye due to flash photography and appropriately correcting the detected red-eye.

With the widespread use of personal computers (PCs) and PDAs (Personal Digital Assistants), more and more digital still cameras (hereinafter referred to as digital cameras) have been used. In recent years, so-called Digital Minilab Systems (e.g., Frontier of Fuji Photo Film Co., Ltd.) have provided a service of outputting an image shot with a digital camera as a photographic print.

The most important factor in a digital camera on which the quality of an image containing a person as in a portrait depends is the finishing of the person, as in a camera using an ordinary film. The red-eye effect that causes a person to have red eyes (pupils) due to light emitted in flash photography presents a serious problem.

An image shot with a digital camera may undergo red-eye correction by way of image data processing. Various types of digital cameras having the red-eye correction function have been proposed.

For example, JP 3114103 B discloses a digital camera (electronic camera) which successively performs flash photography and non-flash photography, compares the results of the two types of the photography to detect red-eye, modifies the image data on flash photography and corrects red-eye, whereby the need for preliminary flashing hitherto practiced for red-eye reduction is eliminated and exhaustion of batteries and dazzling impression on a subject are prevented.

JP 11-127371 A discloses a digital camera (camera system) equipped with a red-eye correction function which comprises correction means for correcting red-eye and recording means for recording, in relation to an image, a signal indicating that the correction means corrected the image, and optionally detection means for detecting photographing conditions which may-invite red-eye, and in which the correction means is used to correct red-eye only in images other than those to which a signal indicating that an image is corrected is assigned and those in which the detection means detected that red-eye may occur during photographing, thus avoiding any unnecessary correction processes.

JP 11-215358 A discloses an image processor which processes an image (data of an image) shot with a digital camera, and in which red-eye correction is performed in accordance with the indication of a red-eye position by an operator and red-eye information including red-eye correction required or not, center position of the corrected red-eye, color information before and after red-eye correction, and number of red-eye correction data (number of pixels) is added to an image file of the original image, whereby the need for cumbersome setting which accompanies red-eye correction in the subsequent reprinting is eliminated.

Such red-eye correction is not always appropriately performed but could often be performed inappropriately. In particular, full-automatic red-eye correction according to JP 3114103 B and JP 11-127371 A sometimes suffers from erroneous red-eye detection as in the case where red-eye cannot be detected although the red-eye actually exists and no correction is performed correspondingly and the case where other portions than the eyes of a person are detected for red-eye, and inappropriate red-eye correction in terms of color tint.

Almost all digital cameras each have a monitor such as a liquid crystal display for checkup of a shot image or a red-eye corrected image on the spot.

Red-eye effect takes place in a greatly limited portion of a human face. In addition, the monitor of a digital camera has insufficient size and resolution to detect red-eye and check the correction result. In other words, it is very difficult for a conventional digital camera to properly check whether red-eye occurs or whether the red-eye has been appropriately corrected.

### SUMMARY OF THE INVENTION

In order to solve the problems of the prior art, the invention aims at providing a digital camera which can appropriately check red-eye and the result of red-eye correction, thus dramatically reducing the load on a digital photo printer in the output of an image including red-eye shot with the digital camera as a red-eye corrected print.

In order to achieve the object described above, the present invention provides a digital camera comprising: photographing means for photoelectrically photographing an image; a display for displaying a photographed image by said photographing means; red-eye processing means for detecting red-eye from said photographed image by said photographing means to generate red-eye position information; and red-eye control means for displaying on said display an enlarged image obtained by enlarging a red-eye region including said detected red-eye from said photographed image by said photographing means in accordance with said red-eye position information generated by said red-eye processing means.

It is preferable that said red-eye processing means further executes red-eye correction to correct said detected red-eye.

It is also preferable that, when said red-eye processing means detects a plurality of red-eye parts, enlarged images obtained by enlarging red-eye regions including said plurality of red-eye parts detected by said red-eye processing means, respectively are sequentially displayed on said display.

It is further preferable that the digital camera further comprises: storing means for storing said photographed image by said photographing means; and recording means for recording said photographed image by said photographing means onto said storing means, wherein said recording means records at least one item selected from the group consisting of said red-eye position information generated by said red-eye processing means, and processing time information for red-eye processing required by said red-eye processing means, or at least one item selected from the group consisting of said red-eye position information, red-eye correction information related to said red-eye correction executed by said red-eye processing means, and said processing time information, as red-eye pertinent information related to said photographed image onto said storing means.

It is also further preferable that the digital camera further comprises: indication means for indicating a detection error of said red-eye processing by said red-eye processing means using said enlarged image of the enlarged red-eye region including the red-eye in the photographed image which is displayed on said display, wherein said recording means records detection error position information concerning a position where said detection error is indicated by said indication means, as said red-eye pertinent information onto said storing means.

It is still further preferable that said recording means records said processing time information as said red-eye pertinent information onto said storing means, and when available memory space of said storing means has dropped below a predetermined volume, said recording means deletes at least one item of said red-eye pertinent information in order, from said photographed image with a shortest processing time of said processing time information.

### BRIEF DESCRIPTION OF THE DRAWINGS

FIG. 1 is a block diagram of an example of a digital camera according to the invention;

FIG. 2 is a flowchart explaining the operation of the digital camera shown in FIG. 1;

FIG. 3A is a conceptual diagram explaining the operation of the digital camera shown in FIG. 1; and

FIG. 3B is another conceptual diagram explaining the operation of the digital camera shown in FIG. 1.

### DETAILED DESCRIPTION OF THE INVENTION

A digital camera according to the invention is described below in detail based on the preferable embodiments shown in the attached drawings.

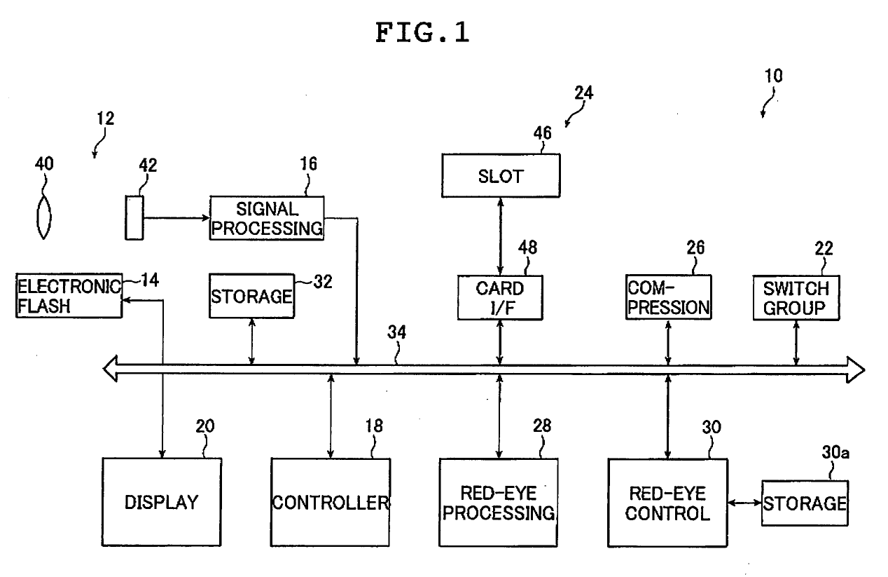

FIG. 1 is a conceptual drawing of an example of the digital camera according to the invention.

A digital camera 10 shown in FIG. 1 (hereinafter simply referred to as a “camera”) basically comprises an optical system 12, an electronic flash 14, a signal processor 16, a controller 18, a display 20, a switch group 22, a recording section 24, compression means 26, red-eye processing means 28, and red-eye control means 30. A numeral 32 in FIG. 1 represents storage means such as a DRAM and 34 a system bus.

The camera 10 is basically a well-known digital camera except that it comprises the red-eye processing means 28 and the red-eye control means 30. Thus, in addition to the components shown, the camera 10 may further comprise various components of a typical digital camera as exemplified by photometric means for determining the exposure, a microphone for recording, an interface (I/F) and a connector for connecting to an external unit such as a personal computer (PC), a zoom mechanism, mechanical shutter and diaphragm, a finder, drive means for various mechanical components, a lamp to indicate the operating state and warning, and a liquid crystal display (LCD) panel for selection/instruction of an operation, as well as means for operating and controlling these components.

The optical system 12 is a photographic optical system of a common digital camera and comprises an imaging lens 40 and an area CCD sensor 42. The electronic flash 14 is one mounted on a common digital camera.

The signal processor 16 processes the signal of a shot image output from the CCD sensor 42 to generate image data of the shot image. For example, the signal processor 16 performs A/D conversion, shading correction, dark current correction, noise reduction and log conversion on the output signal from the CCD sensor 42 and generates the image data of the shot image.

The controller 18 controls the entire camera 10 and comprises a CPU.

The display 20 displays a shot image and screens for various GUI (Graphical User Interface) operations. The display 20 is, for example, an LCD mounted on a typical digital camera.

The switch group 22 comprises various switches for the user to operate the camera 10. As an example, the switch group 22 includes a shutter button, an electronic flash switch, a zoom switch, a mode selection dial for selecting one from various type of photography modes such as portrait photography and landscape photography, a display selector switch or button, and a cross button and an arrow button for making selections. On the camera 10, various operations are performed including operations related to red-eye such as red-eye processing OK, red-eye processing cancellation and instruction of additional processing mentioned later by way of the switches, or the switches as well as the GUI using the display on the screen of the display 20 (and/or said LCD panel).

The recording section 24 records image data of a shot image onto a medium (recording medium) and comprises a slot 46 for loading a medium and a card interface 48 for connecting the slot 46. On the camera 10 shown, for example, image data is recorded onto a medium loaded into the slot 46 in an Exif image file format. Types of a medium applicable to this invention are not particularly limited but media used on a digital camera such as xD-Picture Card™, SmartMedia™, a PC card, and CompactFlash™ can be used.

The compression means 26 compresses the image data of a shot image in order to record the image data onto a medium and generates compressed image data conforming to the JPEG (Joint Photographic Expert Group).

The red-eye processing means 28 detects red-eye on an image shot by the camera 10 by way of image analysis to generate red-eye position information and performs correction of the detected red-eye (hereinafter red-eye detection and red-eye correction are collectively called “red-eye processing”). On the camera 10 according to the invention, the red-eye processing means 28 and the red-eye control means 30 to be mentioned later preferably have dedicated arithmetic means (processing unit) independently of the controller 18.

The camera 10 can perform red-eye detection and red-eye correction in accordance with the user's instruction (manual instruction) so as to recover from failure of automatic red-eye processing by the red-eye processing means 28.

While the illustrated red-eye processing means 28 detects and corrects red-eye as a preferable embodiment, the camera 10 according to the invention is not limited thereto but may only detect red-eye.

The red-eye processing (red-eye detection and correction) methods on the red-eye processing means 28 are not particularly limited but well-known methods are available.

An example pertains to a full automatic red-eye correction method which automatically detects red-eye in an image by way of image analysis and then automatically performs red-eye correction by way of image processing.

The red-eye detection methods are not particularly limited but well-known methods are available. An example pertains to a method which extracts a face image and detects red-eye from the extracted face image.

Face image extraction may be performed using a well-know method. Examples of face image extraction include: a face image detection method by way of edge detection or shape pattern detection; a face image detection method by way of hue extraction or skin tone extraction; a method in which a candidate region is extracted and divided into sub-regions, the characteristic amount of each sub-region is checked by reference to a preset face region pattern, and a face region is extracted based on the accuracy obtained (refer to JP 2000-137788 A); a method in which candidate face regions are extracted and the accuracy is evaluated from the multiplicity between the candidate regions to thereby extract a face region (refer to JP 2000-149018 A); and a method in which candidate face regions are extracted, and in case the density of each candidate region corresponds to a predetermined threshold, candidate body regions are extracted and the accuracy is evaluated by using the density and color saturation contrast of the candidate face and body regions to thereby extract a face region (refer to JP 2000-148980 A).

Methods for detecting red-eye from an extracted face region may be any of the well-known methods. Such methods include: a method in which a pupil is extracted by edge detection or shape pattern detection, or using position information, hue information or any other information and red-eye is detected based on the hue or other factors; a method in which an eye is extracted by edge detection or shape pattern detection or using position information or any other information, a low-luminance region is extracted from the luminance histogram of the image data of the eye, the extracted low-luminance region is compressed to extract a pupil region, and red-eye is detected based on the hue or other factors; and a method in which an image characteristic amount z using a factor such as hue is determined for each pixel of a face candidate region assumed to be on an xy plane to set a three-dimensional space of xyz, the xyz plane is divided based on the mountain-like distribution of z values and red-eye is detected for each region obtained after division based on the shape information and statistical image characteristic amount or the like (refer to JP 2000-76427 A).

Methods for correcting detected red-eye are not particularly limited but well-known methods may be used. Such methods include: a method in which red-eye is corrected by way of color conversion or drop in the saturation of detected red-eye; and a method in which the saturation and lightness are corrected for all the other pixels so that these pixels may approximate an pixel having minimal lightness in the detected red-eye region (refer to JP 2000-76427 A).

The red-eye control means 30 has storage means 30a such as a DRAM and causes a red-eye region in an image to be represented in an enlarged manner on the display 20 in accordance with the red-eye position information generated by the red-eye processor 28.

In the red-eye control means 30, information related to red-eye including red-eye position information generated by the red-eye processing means 28, (red-eye) processing time information as information on time required by the red-eye processor 28 to process red-eye, red-eye correction information related to an image which has undergone red-eye correction by the red-eye processor 28, and cancel information on the cancellation of the red-eye detection by the red-eye processor 28 to be described below due to its improperness are related to the corresponding image data and additionally recorded in an image file of a medium loaded into a slot 46.

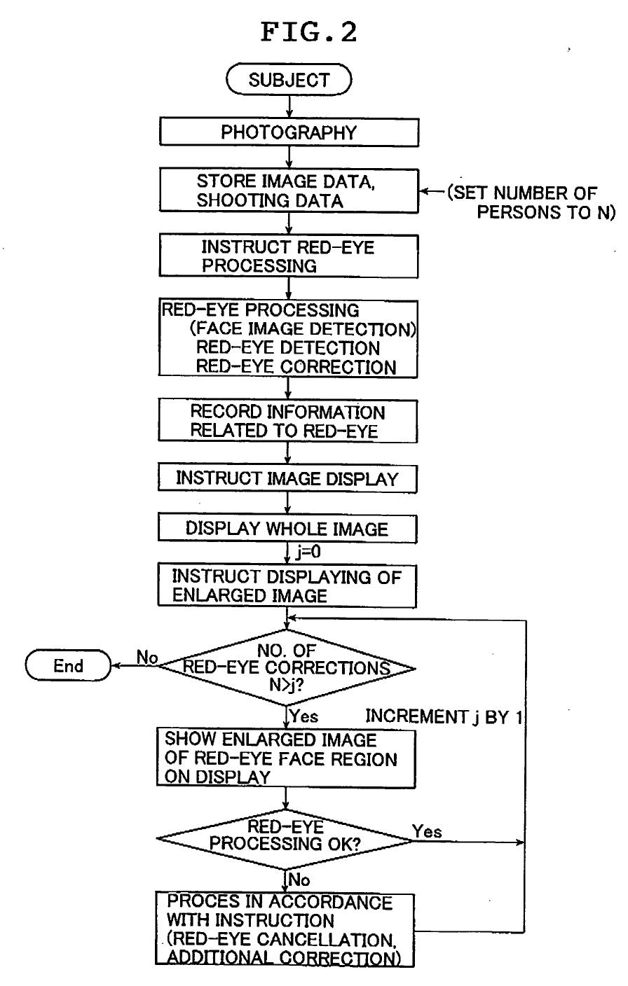

Operation of the camera 10 is described below referring to the flowchart in FIG. 2 in order to detail the red-eye processing means 28 and red-eye control means 30 as well as the digital camera according to the invention.

When a user shoots a subject, the signal processor 16 processes an output signal from the CCD sensor 42 to generate image data of a shot image and the image data is stored into the storage means 32. The compression means 26 then JPEG-compresses the image data. The compressed image data and predetermined information such as presence/absence of flash photography are stored into a predetermined area of an Exif-format image file in a medium loaded into the slot 46.

When one or more persons are photographed, it is preferable to set the number of subjects (N) at photography and record the data in relation to the image data, in order to improve the accuracy of red-eye processing to be mentioned later. The number of subject (N) may be input by the user or an appropriately set default value may be input. In case the accuracy of face image extraction in red-eye processing is high, the number of subjects N may be automatically set depending on the number of extracted face images.

When the user issues an instruction to execute red-eye processing (red-eye processing instruction) after photography, the red-eye processing means 28 starts red-eye processing.

The image subjected to red-eye processing may be an image just shot or an image specified by the user. In case the user issues an instruction for red-eye processing, a plurality of images may be specified at a time. Or, an image shot using an electronic flash may be automatically red-eye-processed. Further, in case a red-eye processing instruction is issued for an image shot without an electronic light, the corresponding warning may be given.

The red-eye processing means 28 reads out image data of an image to undergo red-eye processing from the storage means 32, performs red-eye detection (face image detection) as mentioned earlier to generate red-eye position information and performs red-eye correction. In case no image data remains in the storage means 32, compressed image data may be read out from the medium loaded into the slot 46 and decompress the read out data. Or, image data may be periodically read out from a medium. A person is not the sole subject to undergo the red-eye processing and the red-eye processing may be made on any other animals such as a cat.

In case the number of subjects N is set as mentioned earlier, it is preferable to use N to detect red-eye. This reduces the arithmetic operation volume of red-eye detection as well as prevents an error in red-eye detection.

The red-eye processing means 28 transmits the red-eye position information, red-eye corrected image data (hereinafter referred to as corrected image data), and time required for red-eye processing (time required for red-eye detection including face image detection and red-eye correction) to the red-eye control means 30 for each image.

In the red-eye control means 30, corrected image data is stored into the storage means 30a, and the received red-eye position information, information on the time required for red-eye processing (processing time information) and red-eye correction information on the corrected image data are additionally recorded in relation to the corresponding image as information related to red-eye in a predetermined position of an image file in a medium loaded into the slot 46.

Thus, according to the invention, in case red-eye processing on an image shot with the camera 10 is performed by another unit such as a digital photo printer or a PC or in case red-eye processing is performed again on an image in the image file by using the camera 10, it is possible to dramatically reduce the load of red-eye processing and for example to enhance the productivity of the digital photo printer.

Red-eye correction information includes one or more items of corrected image data, difference data between pre-correction image data and post-correction image data, image data of a region including red-eye extracted from a red-eye corrected image (corrected image data) and the corresponding position information, and red-eye color/density data after correction.

Positions in an image file where information related to red-eye is recorded are not particularly limited but may be determined as appropriate depending on the image file format. Taking as an example an Exif-format image file to record JPEG compressed data as shown, an APPn marker past the application marker segment 3 (APP3) may be used as a position to record information related to red-eye.

While four items of information including red-eye position information, processing time information, red-eye correction information and detection error information to be mentioned later are additionally recorded into an image file as information related to red-eye in this embodiment, the invention is not limited thereto but information to be recorded as information related to red-eye may be one item of information, appropriately selected two or three items of information, or any other number of items of information.

Note that, in typical red-eye processing, red-eye detection takes the longest time and the main cause of inappropriate red-eye processing is an error in red-eye detection. As a result, in order to reduce the load of red-eye processing on another unit, at least red-eye position information is preferably recorded and detection error information is preferably recorded as well.

To record corrected image data as information related to red-eye, original image data, that is, image data before red-eye correction may be deleted from a medium and the corrected image data may be recorded in a position where the original data should be recorded. In usual image data handling, it is more often preferable that original image data be present for appropriate processing. As a rule, original image data is preferably left in the camera 10 according to the invention without being deleted.

In case the medium loaded into the slot 46 is running out of free space, it is preferable to delete at least one item of information related to red-eye for an image whose processing time is shorter by reference to the processing time information on each image recorded onto the medium. This leaves information related to red-eye for an image whose red-eye processing takes time, whereby the processing load can be reduced when red-eye processing is performed again on the camera 10 according to the invention or when red-eye processing on an image shot with the camera 10 according to the invention is performed on another image processor or a digital photo printer. In particular, this method is effective in case corrected image data with large volume is to be left as red-eye correction information.

The information related to red-eye may be totally deleted or only predetermined information may be detected. Items of information related to red-eye to be deleted may be selected. A combination of these processes is also possible. Red-eye detection takes the longest time in usual red-eye processing so that red-eye position information is preferably left in order to reduce the load of subsequent red-eye processing on another unit.

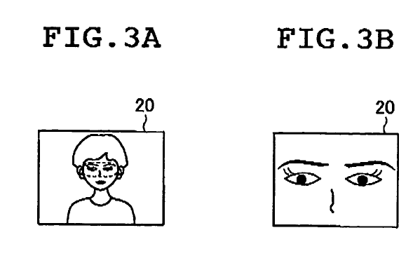

When an image display instruction is issued by a user, in case the specified image is a red-eye corrected image, the red-eye controller 30 reads out corrected image data from the storage means 30a and displays the image (hereinafter referred to as the whole image for the sake of convenience to discriminate from an enlarged image) on the display 20 as shown in FIG. 3A as well as generates an enlarged image of a region containing the red-eye (for example a region surrounded by a dotted line) in the image by using the aforementioned red-eye position information. The red-eye controller 30 then sets j=0 in order to check the number of subjects to be mentioned later.

In case the target image is an image which has not undergone red-eye processing, the image is displayed as usual.

In case the target image is an image which has undergone red-eye processing but is already deleted from the storage means 30a, image data may be read out from the medium and corrected image data may be generated using the information related to red-eye.

In case the target image is an image which has undergone red-eye processing but red-eye is not detected, the information may be displayed as such.

Generation of an enlarged image may be made using a well-known method depending on the number of shot image pixels. The size of an enlarged image on the display 20 is not particularly limited but may be determined as required depending on the size of the display 20. The size of an enlarged image may be fixed or changed as appropriate depending on the size of the face of the person where red-eye correction has been made. Another method may be adopted in which a user can select the size of the enlarged image.

When the user issues an instruction to display an enlarged image, the red-eye control means 30 compares the number of subjects N with j and in case “N>j” is Yes, that is, in case the enlarged images of red-eye as many as the number of subjects shown in the original image are not displayed yet, the red-eye control means 30 shows an enlarged image on the display 20 as shown in FIG. 3B (enlarged display).

An enlarged image need not be shown across the entire screen of the display 20 but may be arranged side by side with a whole image. Or an enlarged image smaller than the screen may be displayed on the whole image. A whole image and an enlarged image may be displayed alternately with a predetermined timing. The position of an enlarged image may be moved in accordance with the input by a user or an enlarged image may be automatically displayed in or moved to a position not related to the checkup of red-eye.

A red-eye corrected section (detected red-eye) is preferably easy to check in an enlarged image and a whole image shown on the display 20.

As an example, a red-eye corrected section may be marked with an arrow or a mark such as ☆ or □ may be provided near a red-eye corrected section or a red-eye corrected section may be surrounded by a frame. The red-eye corrected section may be traced with lines so as to facilitate checkup of the red-eye corrected section.

A method for displaying an image in the invention is not limited to those mentioned above. Only an enlarged image of red-eye may be displayed without using a whole image.

In case red-eye correction is not made, it is possible to provide an enlarged display of the red-eye region in an image not to be red-eye corrected, or further provide a whole image. Even in case red-eye correction is made, only an enlarged display of a non-corrected image may be provided. Moreover, enlarged images before and after red-eye correction (same as above) may be displayed side by side or displayed sequentially or alternately.

When the display 20 shows an enlarged image, a user determines whether the red-eye processing is appropriate.

In case the red-eye processing is appropriate (Yes), the user makes an input as such and increments j by 1 and checks whether “N>j” then displays an enlarged image of the red-eye of another person in the image. Or, in case no input is received although a predetermined time has elapsed after the enlarged image is displayed, an enlarged image of the red-eye of another person in the image may be automatically displayed assuming that the red-eye processing is appropriate.

In case the red-eye processing is inappropriate (No), the camera 10 performs processing in accordance with the instruction input by the user.

Most of the inappropriate cases of red-eye processing are due to an error in red-eye detection, that is, a case where a position other than the eyes of a person (animal) is detected as red-eye and red-eye corrected (darkened) (hereinafter referred to as Error A) and a case where red-eye is not detected as red-eye (hereinafter referred to as Error B).

The operator uses the enlarged image shown on the display 20 to specify the position of the inappropriate red-eye processing and input an indication that the red-eye processing is inappropriate.

The camera 10 recognizes the position where it performed red-eye correction. In case an indication that red-eye correction is inappropriate is input to the position, the camera 10 perceives Error A.

The red-eye control means 30 cancels red-eye detection of this position in accordance with this indication and restores the image data in the corresponding position of the enlarged image and the whole image and image data stored in the storage means 30a to the data of the original image (before red-eye correction), that is, cancels red-eye processing. In case corrected image data is recorded onto a medium as red-eye correction information, the image in the corresponding position of this image is also restored to the original.

Further, in the red-eye control means 30, the cancel information to the effect that red-eye processing in the red-eye detected position is canceled due to a detection error is preferably recorded as information related to red-eye in a predetermined position of an image file (medium). This allows operation such as deselecting the position from the red-eye detection candidates or skipping red-eye correction on detection of red-eye when red-eye processing is performed again on the camera 10 or red-eye processing is performed on the image on another unit, thereby reducing the load of red-eye processing.

The cancel information comprises the information to the effect that red-eye processing is canceled, and any information selected from the information on the center position of red-eye erroneously detected (canceled), information on the number of pixels of the red-eye, and information on the region surrounding the red-eye.

In case, for example, one eye is red-eye corrected and the other eye remains red-eye in an enlarged image shown on the display 20, the user indicates the position of the red-eye and inputs an indication that the red-eye processing is inappropriate. In this way, in case an indication to the effect that the red-eye processing is inappropriate is input to a position where red-eye correction has not been performed, the camera 10 can recognize Error B.

The red-eye processing means 28 detects red-eye again in the proximity of an indicated position, corrects the red-eye, and displays an enlarged image of the red-eye region in accordance with this indication. Or, the user may use an enlarged image to extract red-eye region and detect, correct and provide an enlarged view of the red-eye accordingly. The user may extract red-eye and correct/provide an enlarged view of the red-eye. Or, the user may select one of these procedures. When the user has input an indication that appropriate red-eye processing has been made, the processing is complete. When the user has input an indication that inappropriate red-eye processing has been made, the processing is retried.

The red-eye control means 30 further records the information related to red-eye in accordance with additional red-eye detection and red-eye correction in a predetermined position of an image file. For the same reason as that for the aforementioned Error A, the information to the effect that this red-eye processing is additional processing due to a detection error is preferably added to the information related to red-eye.

It often happens that Error B cannot be detected, unless it takes place in an enlarged image.

In order to solve this problem, if the accuracy of face image extraction for red-eye processing is high, face image extraction may be performed when no red-eye effect occurs by flash photography and an enlarged image of a face may be shown on the display 20 so that occurrence of Error B can be detected.

Error A is easier to detect than Error B. Cancellation of red-eye processing on Error A is easier to process or calculate than additional red-eye processing on Error B.

Thus, on the camera 10 according to the invention, the threshold value for red-eye detection in the red-eye detection algorithm is preferably made adjustable so that Error A is easier to occur than Error B. In this practice, only the position information on red-eye may be acquired so that red-eye processing such as red-eye correction will not be performed.

A case where red-eye detection is appropriate while red-eye correction is inappropriate rarely takes place so that such a case is not given as an exemplary case where red-eye processing is inappropriate. Note that, according to the invention, in case red-eye correction is inappropriate, it is possible to instruct/execute red-eye correction retrial in case red-eye correction is found inappropriate.

In case an eye of a person or an animal that does not suffer from red-eye effect is detected as red-eye followed by red-eye correction, this very often causes no problem of image quality. Thus, in the invention, red-eye correction is not canceled and no further processing is made in this case (red-eye correction may be canceled). In order to reduce load on another unit, the information to the effect that red-eye detection error has taken place is preferably added to the information related to red-eye.

When the processing to offset inappropriate red-eye processing is complete, as in the previous case where red-eye processing is appropriate, j is incremented by 1 to check that N>j and an enlarged image of red-eye of another person in this image is displayed.

Or, an enlarged image of red-eye of another person in this image may be displayed in accordance with the user's instruction to display next enlarged image.

The above routines are repeated and when the relationship N>j holds no longer true, red-eye processing check on this image is complete and processing on another image starts, for example in accordance with the user's instruction.

As understood from the foregoing description, a digital camera according to the invention automatically detects red-eye or further performs red-eye correction and displays an enlarged image of red-eye. This allows the digital camera to appropriately check red-eye and the result of red-eye correction.

It is possible to check red-eye and the result of red-eye correction by using an enlarged image of the red-eye then add a variety of correct information related to the red-eye to an image file. For example, even in case red-eye correction of an image shot with a digital camera according to the invention is made on a digital photo printer, the load can be dramatically reduced.

The technological philosophy behind the invention is also applicable to various types of image processing other than red-eye processing.

For example, in case a digital camera performs correction of distortion of the periphery of an image caused by distortion aberration, that is, aberration correction, an object to be shot as a straight line is detected to generate position information. Then information is added to the image data, aberration correction is made, and an enlarged image is displayed in accordance with the position information, thereby preferably checking whether the aberration correction is appropriate.

While the digital camera according to the invention has been detailed, the invention is not limited to the above embodiment but various improvements and modifications can be made to it without departing from the spirit of the invention.

For example, while an enlarged image or a whole image is shown on a display usually provided on the camera 10 for checkup of a shot image, the invention is not limited thereto but a display dedicated to red-eye checkup may be provided. The camera may be linked to a cell phone and its display may be used to provide an enlarged image or a whole image.

Operation of the flowchart shown in FIG. 2 can be forcibly terminated at any position. Transition to a desired position including the initial mode is allowed.

While an enlarged image is displayed in the order of red-eye processing, the invention is not limited thereto but processing may be made sequentially for example from the shortest red-eye processing.

While image data or information related to red-eye is recorded onto a medium loaded into the slot 46, the storage means 32 or storage means 30a may be used to perform the same operation.

As detailed hereinabove, according to the invention, a digital camera according to the invention can appropriately check red-eye and the result of red-eye correction, thus dramatically reducing the load on a digital photo printer in the output of an image including red-eye shot with the digital camera as a red-eye corrected print.

What is claimed is:

1. A digital camera comprising:
photographing means for photoelectrically photographing an image;
a display for displaying a photographed image by said photographing means;
red-eye processing means for detecting red-eye from said photographed image by said photographing means to generate red-eye position information; and
red-eye control means for displaying on said display an enlarged image obtained by enlarging a red-eye region including said detected red-eye from said photographed image by said photographing means in accordance with said red-eye position information generated by said red-eye processing means.

2. The digital camera according to claim 1, wherein, when said red-eye processing means detects a plurality of red-eye parts, enlarged images obtained by enlarging red-eye regions including said plurality of red-eye parts detected by said red-eye processing means, respectively are sequentially displayed on said display.

3. The digital camera according to claim 1, further comprising:
storing means for storing said photographed image by said photographing means; and
recording means for recording said photographed image by said photographing means onto said storing means,
wherein said recording means records at least one item selected from the group consisting of said red-eye position information generated by said red-eye processing means, and processing time information for red-eye processing required by said red-eye processing means, as red-eye pertinent information related to said photographed image onto said storing means.

4. The digital camera according to claim 3, further comprising:
indication means for indicating a detection error of said red-eye processing by said red-eye processing means using said enlarged image of the enlarged red-eye region including the red-eye in the photographed image which is displayed on said display,
wherein said recording means records detection error position information concerning a position where said detection error is indicated by said indication means, as said red-eye pertinent information onto said storing means.

5. The digital camera according to claim 3, wherein said recording means records said processing time information as said red-eye pertinent information onto said storing means, and
when available memory space of said storing means has dropped below a predetermined volume, said recording means deletes at least one item of said red-eye pertinent information in order, from said photographed image with a shortest processing time of said processing time information.

6. The digital camera according to claim 1, wherein said red-eye processing means further executes red-eye correction to correct said detected red-eye.

7. The digital camera according to claim 6, further comprising:
storing means for storing said photographed image by said photographing means; and
recording means for recording said photographed image by said photographing means onto said storing means,
wherein said recording means records at least one item selected from the group consisting of said red-eye position information generated by said red-eye processing means, red-eye correction information related to said red-eye correction executed by said red-eye processing means, and processing time information for red-eye processing required by said red-eye processing means, as red-eye pertinent information related to said photographed image onto said storing means.

8. The digital camera according to claim 7, further comprising:
indication means for indicating a detection error of said red-eye processing by said red-eye processing means using said enlarged image of the enlarged red-eye region including the red-eye in the photographed image which is displayed on said display,
wherein said recording means records detection error position information concerning a position where said detection error is indicated by said indication means, as said red-eye pertinent information onto said storing means.

9. The digital camera according to claim 7, wherein said recording means records said processing time information as said red-eye pertinent information onto said storing means, and
when available memory space of said storing means has dropped below a predetermined volume, said recording means deletes at least one item of said red-eye pertinent information in order, from said photographed image with a shortest processing time of said processing time information.
